(19) United States
(12) Patent Application Publication
(10) Pub. No.: US 2015/0275036 A1
(43) Pub. Date: Oct. 1, 2015

(54) INTERMEDIATE COATING COMPOSITION, MULTILAYERED COATING FILM, AND METHOD FOR FORMING THE MULTILAYERED COATING FILM

(71) Applicants: NIPPON PAINT CO., LTD., Osaka-shi (JP); TOYOTA JIDOSHA KABUSHIKI KAISHA, Toyota-shi (JP)

(72) Inventors: Hideki ICHIMURA, Neyagawa-shi (JP); Takashi Irie, Neyagawa-shi (JP); Yoshikazu Kasahara, Neyagawa-shi (JP); Yoshinobu Watanabe, Toyota-shi (JP); Masahiko Ishii, Okazaki-shi (JP); Eisaku Okada, Okazaki-shi (JP)

(73) Assignees: NIPPON PAINT CO., LTD., Osaka-shi (JP); TOYOTA JIDOSHA KABUSHIKI KAISHA, Toyota-shi (JP)

(21) Appl. No.: 14/662,750

(22) Filed: Mar. 19, 2015

(30) Foreign Application Priority Data
Mar. 26, 2014 (JP) 2014-064862
Feb. 16, 2015 (JP) 2015-028103

(51) Int. Cl. C09D 175/06; C25D 5/48

(52) U.S. Cl. CPC C09D 175/06; C25D 5/48

(57) ABSTRACT

An intermediate coating composition used in forming an intermediate coating layer directly overlaid on the surface of an electrodeposition coating layer constructing a vehicle outer panel, wherein a coating film obtained by curing of the intermediate coating composition alone has following characteristics (1) to (4): (1) a loss tangent (tan δ) at −20° C. as determined from a measurement of a dynamic viscoelasticity under a condition involving a rate of temperature rise of 2° C./min and a frequency of 8 Hz being 0.01 to 0.5; (2) a dynamic glass transition temperature being −15° C. to 55° C.; (3) percentage of elongation at −20° C. being 1% to 250%; and (4) a Young's modulus at −20° C. being 400 kgf/cm² to 50,000 kgf/cm². The coating film obtained from the intermediate coating composition preferably further has the following characteristic (5): a tensile strength at −20° C. being 200 kgf/cm² to 1,200 kgf/cm².

### BACKGROUND OF THE INVENTION

1. Field of the Invention

The present invention relates to an intermediate coating composition, a multilayered coating film, and a method for forming the multilayered coating film.

2. Discussion of the Background

For example, in a high-speed operation of automobiles, collision of pebbles and the like onto painted faces of outer panels of the automobiles is inevitable. Due to the collision of the pebbles and the like, damaging phenomena such as cracking and flaking on the coating film of the vehicle outer panel (chipping, as generally referred to) may be caused. When such chipping is caused, water and the like would penetrate from this area, and thus rusting of the foundation material of the outer panel may be caused.

Particularly, in cold foreign countries such as North America, Canada and North Europe, a large amount of rock salts and sand are dispersed on the road surface in winter season for thawing snow; therefore, chipping resistance on coating films of outer panels of automobiles, in particular, is important, and coating films not accompanied by breakage and/or flaking of the coating film even if pebbles collided have been desired, whereby the foundation materials of vehicle outer panels would be prevented from rusting.

In general, in paint application of outer panels of automobiles, an electrodeposition paint (undercoating paint), an intermediate coating paint and a top coating paint are sequentially applied on a steel plate which had been subjected to iron phosphate/zinc phosphate chemical conversion coating. In order to improve chipping resistance and in turn, a rust-preventive property, chipping-resistant primers to be applied between an electrodeposition coating layer and an intermediate coating layer, and the like have been developed (see, Japanese Unexamined Patent Application, Publication Nos. H6-41494, H6-93227, H6-322059, H6-346024, H7-228834, H9-241580, 2002-180000 and 2010-82554). However, coating of these chipping-resistant primers may result in an increase in production cost, contrary to demands for the present, i.e., a reduction in cost.

On the other hand, a technique of imparting chipping resistance to the intermediate coating layer was also developed (see, Japanese Unexamined Patent Application, Publication Nos. H4-77580, 2011-50916 and 2011-20104). However, these techniques also fail to attain sufficient chipping resistance under the current situation.

Therefore, in the paint application of outer panels of automobiles, more superior chipping resistance is desired for the intermediate coating layer. The same applies to external paint application of motor cycles, automobile accessories, fork-lift trucks, heavy equipment, and the like.

### PRIOR ART DOCUMENTS

### Patent Documents

Patent Document 1: Japanese Unexamined Patent Application, Publication No. H6-41494

Patent Document 2: Japanese Unexamined Patent Application, Publication No. H6-93227

Patent Document 3: Japanese Unexamined Patent Application, Publication No. H6-322059

Patent Document 4: Japanese Unexamined Patent Application, Publication No. H6-346024

Patent Document 5: Japanese Unexamined Patent Application, Publication No. H7-228834

Patent Document 6: Japanese Unexamined Patent Application, Publication No. H9-241580

Patent Document 7: Japanese Unexamined Patent Application, Publication No. 2002-180000

Patent Document 8: Japanese Unexamined Patent Application, Publication No. 2010-82554

Patent Document 9: Japanese Unexamined Patent Application, Publication No. H4-77580

Patent Document 10: Japanese Unexamined Patent Application, Publication No. 2011-50916

Patent Document 11: Japanese Unexamined Patent Application, Publication No. 2011-20104

### SUMMARY OF THE INVENTION

The present invention was made in view of the foregoing circumstances, and an object of the invention is to provide an intermediate coating composition, a multilayered coating film, and a multilayered coating film-forming method, which lead to superior chipping resistance even when a chipping-resistant primer is not applied.

According to an aspect of the present invention made for solving the aforementioned problems, an intermediate coating composition used in forming an intermediate coating layer directly overlaid on a surface of an electrodeposition coating layer constructing a vehicle outer panel is provided, wherein a coating film obtained by curing of the intermediate coating composition alone has following characteristics (1) to (4):

(1) a loss tangent (tan δ) at −20° C. as determined from a measurement of a dynamic viscoelasticity under a condition involving a rate of temperature rise of 2° C./min and a frequency of 8 Hz being no less than 0.01 and no greater than 0.5;

(2) a dynamic glass transition temperature (dynamic Tg) being no less than −15° C. and no greater than 55° C.;

(3) percentage of elongation at −20° C. being no less than 1% and no greater than 250%; and

(4) a Young's modulus at −20° C. being no less than 400 kgf/cm² and no greater than 50,000 kgf/cm².

According to another aspect of the present invention made for solving the aforementioned problems, a multilayered coating film comprises: an electrodeposition coating layer constructing a vehicle outer panel; an intermediate coating layer directly overlaid on a surface of the electrodeposition coating layer; and a top coating layer overlaid on a surface of the intermediate coating layer, wherein the intermediate coating layer is formed from the intermediate coating composition.

According to yet another aspect of the present invention made for solving the aforementioned problems, a multilayered coating film-forming method includes the steps of: forming an electrodeposition coating layer constructing a vehicle outer panel; directly forming an intermediate coating layer overlaid on the surface of the electrodeposition coating layer; and forming a top coating layer overlaid on the surface of the intermediate coating layer, wherein the intermediate coating composition described above is applied in the step of forming the intermediate coating layer.

As referred to herein, the “loss tangent (tan δ)” is a value determined in accordance with a tensile vibration-non-resonance method specified in JIS-K7244-4: 1999, and may be determined using, for example, an enforced stretching vibration type viscoelasticity meter such as “Vibron” available from ORIENTEC Co., LTD.

According to the intermediate coating composition, the multilayered coating film and the multilayered coating film-forming method of the aspects of the present invention, formation of a multilayered coating film that is superior in chipping resistance is enabled even when a chipping-resistant primer is not applied.

### DESCRIPTION OF EMBODIMENTS

The embodiments of the present invention involve an intermediate coating composition, a multilayered coating film and a multilayered coating film-forming method, and these will be explained below.

### Intermediate Coating Composition

The intermediate coating composition according to the embodiment of the present invention is used for providing an intermediate coating layer directly overlaid on the surface of an electrodeposition coating layer constructing a vehicle outer panel.

With respect to the intermediate coating composition, the coating film obtained by curing thereof alone has the following characteristics (1) to (4), and preferably further has the following characteristic (5):

(1) a loss tangent (tan δ) at −20° C. as determined from a measurement of a dynamic viscoelasticity under a condition involving a rate of temperature rise of 2° C./min and a frequency of 8 Hz being no less than 0.01 and no greater than 0.5;

(2) a dynamic glass transition temperature (dynamic Tg) being no less than −15° C. and no greater than 55° C.;

(3) percentage of elongation at −20° C. being no less than 1% and no greater than 250%;

(4) a Young's modulus at −20° C. being no less than 400 kgf/cm² and no greater than 50,000 kgf/cm²; and

(5) a tensile strength at −20° C. being no less than 200 kgf/cm² and no greater than 1,200 kgf/cm².

(1) Loss Tangent (tan δ) at −20° C. of Coating Film being No Less than 0.01 and No Greater than 0.5

When the loss tangent (tan δ) of the coating film falls within such a range, inhibition of flaking of the multilayered coating film upon chipping is enabled, together with the plating layer formed on the material to be coated. Thus, the foundation material such as a steel plate can be prevented from exposure resulting from chipping, whereby rusting of the foundation material can be suppressed. In order to more suitably achieve such an effect, the lower limit of the loss tangent (tan δ) at −20° C. of the coating film is preferably 0.02, and more preferably 0.025. On the other hand, the upper limit of the loss tangent (tan δ) is preferably 0.45, and more preferably 0.4.

(2) Dynamic Glass Transition Temperature (Dynamic Tg) of Coating Film being No Less than −15° C. and No Greater than 55° C.

When the dynamic glass transition temperature (dynamic Tg) of the coating film falls within such a range, inhibition of flaking of the multilayered coating film upon chipping is enabled, together with the plating layer formed on the material to be coated. Thus, the foundation material such as a steel plate can be prevented from exposure resulting from chipping, whereby rusting of the foundation material can be suppressed. In order to more suitably achieve such an effect, the upper limit of the dynamic glass transition temperature (dynamic Tg) of the coating film is preferably 45° C., and more preferably 30° C.

(3) Percentage of Elongation at −20° C. of Coating Film being No Less than 1% and No Greater than 250%

When the percentage of elongation of the coating film falls within such a range, inhibition of flaking of the multilayered coating film upon chipping is enabled, together with the plating layer formed on the material to be coated. Thus, the foundation material such as a steel plate can be prevented from exposure resulting from chipping, whereby rusting of the foundation material can be suppressed. In order to more suitably achieve such an effect, the lower limit of the percentage of elongation at −20° C. of the coating film is preferably 4%, and more preferably 6%. The upper limit of the percentage of elongation is preferably 230%, and more preferably 210%.

(4) Young's Modulus at −20° C. of Coating Film being No Less than 400 kgf/cm² and No Greater than 50,000 kgf/cm²

When the Young's modulus of the coating film falls within such a range, inhibition of flaking of the multilayered coating film upon chipping is enabled, together with the plating layer formed on the material to be coated. Thus, the foundation material such as a steel plate can be prevented from exposure resulting from chipping, whereby rusting of the foundation material can be suppressed. In order to more suitably achieve such an effect, the lower limit of the Young's modulus at −20° C. of the coating film is preferably 500 kgf/cm², and more preferably 650 kgf/cm². The upper limit of the Young's modulus is preferably 30,000 kgf/cm², and more preferably 20,000 kgf/cm².

(5) Tensile Strength at −20° C. of Coating Film being No Less than 200 kgf/cm² and No Greater than 1,200 kgf/cm²

When the tensile strength of the coating film falls within such a range, the flaking area of the coating film upon chipping can be decreased. In order to more suitably achieve such an effect, the lower limit of the tensile strength of the coating film at −20° C. is more preferably 350 kgf/cm², and still more preferably 400 kgf/cm². The upper limit of the tensile strength is more preferably 1,000 kgf/cm², and still more preferably 800 kgf/cm². It is to be noted that the tensile strength as referred to herein means a maximum tensile stress that the intermediate coating layer can withstand while being stretched or pulled before breaking.

The intermediate coating composition contains a resin component. The resin component is exemplified by (a) a polycaprolactonetriol, (b) a blocked isocyanate, (c) a polyester resin, and (d) an acrylic resin. The intermediate coating paint may also contain (e) a pigment component such as a laminar filler, and/or any other component except for these components.

The intermediate coating composition preferably contains the polycaprolactonetriol (a) and the blocked isocyanate (b) as resin components. In this instance, a urethane resin having a comparatively dense three-dimensional network structure having many crosslinking points will be provided. Thus, the intermediate coating layer formed from the intermediate coating composition has superior flexibility and elasticity, and in turn, is expected to be capable of providing superior cushioning characteristics. These features enable the intermediate coating composition to form an intermediate coating layer having superior chipping resistance. In addition, the intermediate coating composition preferably contains the laminar filler as (e) a pigment component. In this instance, the toughness of the intermediate coating layer can be improved due to a layer structure of the laminar filler, also leading to enhanced chipping resistance. Hereinafter, each component will be explained.

### (a) Polycaprolactonetriol

The polycaprolactonetriol (a) has influences on the loss tangent (tan δ), the percentage of elongation, the dynamic Tg and the Young's modulus. More specifically, when the amount of the polycaprolactonetriol (a) is greater, the loss tangent (tan δ) and the percentage of elongation tend to be greater, whereas the dynamic Tg and the Young's modulus tend to be smaller. To the contrary, when the amount of the polycaprolactonetriol (a) is smaller, the loss tangent (tan δ) and the percentage of elongation tend to be smaller, whereas the dynamic Tg and Young's modulus tend to be greater.

The polycaprolactonetriol (a) is a compound having, for example, a structure represented by the following formula. The polycaprolactonetriol (a) represented by the following formula may be obtained by, for example, adding ε-caprolactone to a triol.

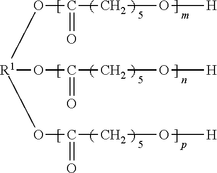

In the above formula, R¹ represents a group derived from a triol; m and n are each independently an integer of 0 or greater; and p is an integer of 1 or greater, wherein the sum of m, n and p is 2 or greater.

Examples of the group derived from a triol represented by R¹ include a 2,2-dimethylbutane-triyl group, a propane-1,2,3-triyl group, a triethylamine-triyl group, and the like.

Examples of the triol that gives R¹ include trimethylolpropane, glycerin, triethanolamine, and the like. The triol preferably has carbon atoms of preferably no less than 2 and no greater than 8, and more preferably no less than 3 and no greater than 6.

The lower limit of the number average molecular weight (Mn) of the polycaprolactonetriol (a) is preferably 200, and more preferably 400. The upper limit of the number average molecular weight (Mn) is preferably 4,000, and more preferably 3,000. When the number average molecular weight (Mn) falls within such a range, chipping resistance can be improved. It is to be noted that the number average molecular weight as referred to herein is a value as determined by gel permeation chromatography using mono-dispersed polystyrene as a standard.

As the polycaprolactonetriol (a), a commercially available product may be also used. Examples of the commercially available product of the polycaprolactonetriol (a) include “PLACCEL 303”, “PLACCEL 305”, “PLACCEL 308”, “PLACCEL 309”, “PLACCEL 312” and “PLACCEL 320” (Daicel Chemical Industries, Ltd.,) and the like.

The lower limit of the percentage content of the polycaprolactonetriol (a) in the entire resin components is preferably 10% by mass, and more preferably 15% by mass. The upper limit of the percentage content is preferably 60% by mass, and more preferably 50% by mass. When the percentage content is less than the lower limit described above, chipping resistance will be inferior, whereby flaking of the coating film may be caused. Whereas, when the percentage content exceeds the upper limit described above, the hardness of the coating film may be decreased. In addition, setting of the percentage content of the polycaprolactonetriol (a) to fall within the above range enables the loss tangent (tan δ) value, percentage of elongation and Young's modulus at a low temperature of about −20° C. to be optimized, and also the dynamic glass transition temperature (dynamic Tg) can be optimized. Therefore, flaking of the coating film together with the plating of the material to be coated upon chipping can be inhibited, and thus an exposure of the material to be coated (foundation material) such as a steel plate through chipping can be inhibited. It is to be noted that the “percentage content in entire resin components” as referred to herein means a percentage content in entire resin components in terms of solid component equivalent. Furthermore, also the “percentage content in entire resin components” of resin components other than the polycaprolactonetriol (a) is similarly defined.

### (b) Blocked Isocyanate

The blocked isocyanate (b) has influences on the loss tangent (tan δ), the percentage of elongation, the dynamic Tg, the Young's modulus and the tensile strength. More specifically, when the amount of the blocked isocyanate (b) is greater, the loss tangent (tan δ) and the percentage of elongation will be smaller, whereas the dynamic Tg, the Young's modulus and the tensile strength will be greater. To the contrary, when the amount of the blocked isocyanate (b) is smaller, the loss tangent (tan δ) and the percentage of elongation will be greater, and the dynamic Tg, the Young's modulus and the tensile strength will be smaller.

The blocked isocyanate (b) is a compound prepared by blocking isocyanate groups of a polyisocyanate with a blocking agent. The polyisocyanate is a compound having at least two isocyanate groups in one molecule. The blocking agent is a compound which is added to an isocyanate group, and is stable at a normal temperature, but can regenerate a free isocyanate group upon heating at a temperature higher than the dissociation temperature.

Examples of the polyisocyanate include:

aliphatic polyisocyanates such as hexamethylene diisocyanate (HDI), 2,2,4-trimethylhexane diisocyanate and lysine diisocyanate;

alicyclic polyisocyanates such as 1,4-cyclohexane diisocyanate (CDI), isophorone diisocyanate (IPDI), 4,4′-dicyclohexylmethane diisocyanate (hydrogenerated MDI), methylcyclohexane diisocyanate, isopropylidenedicyclohexyl-4,4′-diisocyanate, 1,3-diisocyanatomethylcyclohexane (hydrogenerated XDI), 1-methylcyclohexan-2,4-diyldiisocyanate (hydrogenerated TDI) and 2,5- or 2,6-bis(isocyanatomethyl)-bicyclo[2.2.1]heptane(norbornane diisocyanate);

aromatic polyisocyanates such as tolylene diisocyanate (TDI), diphenylmethane diisocyanate (MDI), p-phenylene diisocyanate and naphthalene diisocyanate;

aromatic-aliphatic polyisocyanates such as xylylene diisocyanate (XDI) and tetramethylxylylene diisocyanate (TMXDI);

modified products (urethanated products, carbodiimides, uretdiones, uretoneimines, burettes and/or isocyanurate-modified products) of these polyisocyanates; and the like. These polyisocyanates may be used either alone of one type, or two or more types thereof may be used in combination.

Examples of the blocking agent include:

lactam-based blocking agents such as ε-caprolactam, δ-valerolactam, γ-butyrolactam and β-propiolactam;

glycol ether-based blocking agents, e.g., ethylene glycol monoalkyl ether-based blocking agents such as ethylene glycol monomethyl ether, ethylene glycol monoethyl ether, ethylene glycol monobutyl ether, diethylene glycol monomethyl ether and ethylene glycol mono-2-ethylhexyl ether;

propylene glycol monoalkyl ether-based blocking agents such as propylene glycol monomethyl ether and propylene glycol monoethyl ether; and the like.

As the blocking agent, other active hydrogen-containing blocking agent may be used in combination, in addition to the lactam-based blocking agent and the glycol ether-based blocking agent.

Examples of the other active hydrogen-containing blocking agent include:

phenol-based blocking agents such as phenol, cresol, xylenol, chlorophenol and ethylphenol;

active methylene-based blocking agents such as ethyl acetoacetate and acetylacetone;

alcohol-based blocking agents such as methanol, ethanol, propanol, butanol, amyl alcohol, benzyl alcohol, methyl glycolate, butyl glycolate, diacetone alcohol, methyl lactate, ethyl lactate and 2-ethylhexanol;

oxime-based blocking agents such as formaldoxime, acetoaldoxime, acetoxime, methylethylketoxime, diacetylmonooxime and cyclohexaneoxime;

mercaptan-based blocking agents such as butyl mercaptan, hexyl mercaptan, t-butyl mercaptan, thiophenol, methylthiophenol and ethylthiophenol;

acid amide-based blocking agents such as acetic acid amide and benzamide;

imide-based blocking agents such as succinic acid imide and maleic acid imide;

imidazole-based blocking agents such as imidazole and 2-ethylimidazole;

pyrazole-based blocking agents;

triazole-based blocking agents; and the like.

An equimolar blocking agent to the isocyanate groups of the polyisocyanate is generally used in the preparation of the blocked isocyanate (b).

The blocked isocyanate (b) is preferably HDI blocked with the oxime-based blocking agent or the pyrazole-based blocking agent.

The lower limit of the percentage content of the blocked isocyanate (b) in the entire resin components is preferably 1% by mass, more preferably 5% by mass, and still more preferably 10% by mass. The upper limit of the percentage content is preferably 50% by mass, more preferably 40% by mass, and still more preferably 35% by mass. When the percentage content is less than the lower limit described above, the hardness and/or the adhesiveness of the coating film may be decreased. Whereas, when the percentage content is greater than the upper limit described above, the chipping resistance may be inferior.

The lower limit of a molar ratio of the isocyanate groups of the blocked isocyanate (b) to OH groups of the polycaprolactonetriol (a) (hereinafter, may be also referred to as “NCO/OH ratio”) is preferably 0.1, and more preferably 0.3. The upper limit of the NCO/OH ratio is preferably 3.0, and more preferably 2.5. When the NCO/OH ratio is less than the lower limit described above, the hardness and/or the adhesiveness of the coating film may be decreased. To the contrary, when the NCO/OH ratio is greater than the upper limit described above, the appearance may be deteriorated. In addition, the NCO/OH ratio falling within the above range enables the tensile strength value at a low temperature to be optimized, and is effective in decreasing a flaking area upon chipping.

### (c) Polyester Resin

The polyester resin (c) has influences on the loss tangent (tan δ), the percentage of elongation, the dynamic Tg and the Young's modulus. More specifically, when the polyester resin (c) is contained in a larger amount, the loss tangent (tan δ) and the percentage of elongation tend to be greater, whereas the dynamic Tg and the Young's modulus tend to be smaller. To the contrary, when the polyester resin (c) is contained in a smaller amount, the loss tangent (tan δ) and the percentage of elongation tend to be smaller, whereas the dynamic Tg and the Young's modulus tend to be greater.

The polyester resin (c) is a resin having an ester bond in the main chain, but those corresponding to the polycaprolactonetriol (a) are excluded. When the intermediate coating composition contains a polyester resin, suitability for paint application, and the dispersibility of the pigment component can be improved.

The polyester resin (c) is exemplified by a saturated polyester, an unsaturated polyester, and the like. Such a polyester resin (c) may be obtained by, for example, heat condensation of a polybasic acid with a polyhydric alcohol. The polybasic acid is exemplified by a saturated polybasic acid or an anhydride thereof, an unsaturated polybasic acid or an anhydride thereof, and the like. Examples of the saturated polybasic acid and the anhydride thereof include phthalic anhydride, terephthalic acid, succinic acid, and the like. Examples of the unsaturated polybasic acid and the anhydride thereof include maleic acid, maleic anhydride, fumaric acid, and the like. The polyhydric alcohol is exemplified by a divalent alcohol, a trivalent alcohol, and the like. Examples of the divalent alcohol include ethylene glycol, diethylene glycol, and the like. Examples of the trivalent alcohol include glycerin, trimethylolpropane, and the like. These polyester resins may be used alone, or a plurality of these polyester resins may be used in combination.

The lower limit of the number average molecular weight of the polyester resin (c) is preferably 500, and more preferably 800. The upper limit of the number average molecular weight is preferably 6,000, and more preferably 5,000.

The upper limit of the percentage content of the polyester resin (c) in entire resin components is preferably 60% by mass, and more preferably 55% by mass. The lower limit of the percentage content is preferably 10% by mass, and more preferably 20% by mass.

### (d) Acrylic Resin

The acrylic resin (d) has influences on the loss tangent (tan δ), the percentage of elongation, the dynamic Tg, Young's modulus and the tensile strength. More specifically, when the amount of the acrylic resin (d) is greater, the loss tangent (tan δ) and the percentage of elongation tend to be smaller, whereas the dynamic Tg, the Young's modulus and the tensile strength tend to be greater. To the contrary, when the amount of the acrylic resin (d) is smaller, the loss tangent (tan δ) and the percentage of elongation tend to be greater, whereas the dynamic Tg, the Young's modulus and the tensile strength tend to be smaller.

The acrylic resin (d) is a resin having a structural unit derived from a monomer having an acryloyl group or a methacryloyl group. Such a monomer is exemplified by (meth)acrylic acid, a (meth)acrylic acid ester, and the like. It is to be noted that the term “(meth)acrylic acid or (meth)acrylate” is a generic name of acrylic acid and methacrylic acid, or methacrylate and acrylate, and each means either one or both thereof.

As the acrylic resin (d), an acrylic resin having two or more hydroxyl groups in one molecule is preferably used. Examples of the monomer that gives such an acrylic resin (d) include hydroxymethyl (meth)acrylate, hydroxyethyl (meth)acrylate, hydroxypropyl (meth)acrylate, hydroxybutyl (meth)acrylate, N-methylolacrylamide, and the like.

As the acrylic resin (d), a lactone-modified product of the acrylic resin having hydroxyl groups described above is also suitably used. The lactone used in the modification is preferably ε-caprolactone.

In addition, when the acrylic resin (d) having a glass transition temperature appropriately adjusted is used, characteristics such as chipping resistance of the intermediate coating composition can be improved.

The lower limit of the number average molecular weight of the acrylic resin (d) is preferably 2,000, and more preferably 2,500. The upper limit of the number average molecular weight is preferably 8,000, and more preferably 7,000. When the number average molecular weight falls within the above range, the chipping resistance can be improved.

The lower limit of the percentage content of the acrylic resin (d) with respect to the entire resin components is preferably 10% by mass, and more preferably 20% by mass. The upper limit of the percentage content is preferably 60% by mass, and more preferably 50% by mass. When the percentage content falls within the above range, the chipping resistance can be improved.

### (e) Pigment Component

The pigment component (e) is not particularly limited, and is exemplified by inorganic pigments such as titanium white, carbon black and iron oxide; organic pigments; extender pigments such as talc and sedimentary barium sulfate; and the like. In particular, a pigment component having a layer structure, i.e., a laminar filler is preferred. Examples of the laminar filler include talc, aluminum hydroxide, magnesium hydroxide, kaolinite, mica and the like, and of these, talc is preferred.

The talc is exemplified by well-known talc such as S talc and PS talc, and the like.

The mean particle size of the laminar filler is typically no less than 1 μm and no greater than 10 μm, and preferably about 5 μm. When the mean particle size falls within the above range, deterioration of the appearance of the coating film can be further inhibited. When the mean particle size is less than 1 μm, the effect of improving the chipping resistance due to the laminar filler may be insufficient. To the contrary, when the mean particle size is greater than 10 μm, the appearance may be deteriorated. It is to be noted that the mean particle size of the laminar filler as referred to herein means a median diameter derived from the volume distribution determined according to a laser diffraction scattering method.

The lower limit of the pigment mass concentration of the laminar filler is preferably 0.5% by mass. The upper limit of the pigment mass concentration of the laminar filler is preferably 10% by mass, and more preferably 5% by mass. When the pigment mass concentration of the laminar filler is less than the lower limit described above, the chipping resistance is impaired, and thus flaking of the electrodeposition coating layer may occur. On the other hand, when the pigment mass concentration of the laminar filler is greater than the upper limit described above, the adhesiveness of the coating film may be decreased. Moreover, the amount remaining after heating (NV) of the intermediate coating composition is reduced, whereby the smoothness may be deteriorated.

The term “pigment mass concentration” as referred to herein means a value (% by mass) calculated in accordance with a formula of: (mass of pigment component)×100/(mass of entire pigment components+mass of entire resin components in terms of solid component equivalent).

The pigment mass concentration of the pigment component other than the laminar filler is preferably no greater than 70% by mass, and more preferably no greater than 60% by mass. When the pigment mass concentration of the pigment component other than the laminar filler is greater than the upper limit described above, coating properties of the paint may be deteriorated, and thus the smoothness of the coating film may be deteriorated.

### Other Component(s)

The intermediate coating paint may contain other component(s) such as an epoxy resin, a melamine resin, a urethane curing catalyst, etc.

In addition, the intermediate coating composition may be used as any one of a water-based paint and an organic solvent-based paint. In a case where the intermediate coating composition is used as an organic solvent-based paint, one, or two or more types of organic solvents such as: aromatic hydrocarbons such as toluene and xylene; aliphatic hydrocarbons such as mineral spirit; esters such as ethyl acetate and butyl acetate; ketones such as methyl ethyl ketone may be contained as a solvent.

### Multilayered Coating Film-Forming Method

The multilayered coating film-forming method according to the embodiment of the present invention may be applied to formation of outer panels of automobiles, as well as other outer panels of motor cycles, fork-lift trucks, heavy equipment, etc., for which chipping resistance is required, and automobile accessories, and the like. Hereinafter, the multilayered coating film-forming method will be explained with reference to a method for forming a multilayered coating film constructing an outer panel of an automobile, by way of an example. However, the multilayered coating film-forming method is not limited to the method described below.

The multilayered coating film-forming method according to the embodiment of the present invention includes: an electrodeposition coating layer-forming step; an intermediate coating layer forming-step; and a top coating layer-forming step.

### Electrodeposition Coating Layer-Forming Step

The electrodeposition coating layer-forming step can be accomplished by carrying out well-known electrodeposition paint application, followed by baking.

Electrodeposition Paint Application

The electrodeposition paint application is a procedure in which a material to be coated is immersed in an electrodeposition paint, and electrification therebetween leads to deposition of a charged resin component onto the material to be coated.

As the material to be coated, a steel plate or the like may be used. Also, prior to carrying out the electrodeposition paint application onto the material to be coated, plating or chemical conversion coating may be conducted onto the material to be coated, and it is preferred that the chemical conversion coating is conducted after conducting the plating onto the material to be coated. The chemical conversion coating is exemplified by a procedure in which an iron phosphate/zinc phosphate chemical conversion coating agent is used. The plating is exemplified by a zinc plating, and the like.

The electrodeposition paint is a water soluble paint or water dispersion type paint prepared by dissolving or dispersing the resin component in water. In the case where the resin component is an acidic resin, the electrodeposition paint may be prepared by neutralizing with a base such as ammonia, an amine or an inorganic alkali, and the neutralized matter is dissolved or dispersed in water. On the other hand, in the case where the resin component is a basic resin, the electrodeposition paint may be prepared by neutralizing with an acid such as acetic acid, lactic acid, boric acid or phosphoric acid, and the neutralized matter is dissolved or dispersed in water.

As the electrodeposition paint, any one of an anionic resin-based paint and a cationic resin-based paint may be used, and a cationic resin-based paint is preferred in light of an anticorrosion property.

Examples of the resin component of the electrodeposition paint include: drying oil; liquid rubber-based resins such as polybutadiene; maleinized oil resins; maleinized polybutadiene; amine epoxidized polybutadiene; fatty acid ester resins of a resinous polyol, or modified derivatives thereof (for example, epoxidation products, esterification products); alkyd resins; acrylic resins; and the like.

The electrodeposition paint may be appropriately blended with a conventionally employed additive such as a crosslinking agent such as a melamine resin and a blocked isocyanate, a pigment, a solvent, and the like.

The condition of the electrodeposition paint application is preferably predetermined so as to give the film thickness of the electrodeposition coating layer of no less than 10 μm and no greater than 40 μm after baking as described later, and typically involves an application voltage of no less than 200 V and no greater than 300 V, and an application time period of no less than 90 sec and no greater than 300 sec. As a matter of course, the condition of the electrodeposition paint application may be appropriately predetermined in accordance with the type of the electrodeposition paint used, intended film thickness of the deposition film, and the like. It is to be noted that the “film thickness” as referred to means a value determined in accordance with JIS-K5600-1-7: 1999 (“Testing methods for paints—Part 1: General rule—Section 7: Determination of film thickness”). The same applies to the “film thickness” as referred to herein below.

Baking

The baking after the electrodeposition paint may be carried out in accordance with a conventional method as long as the resin component in the electrodeposition paint can be fixed to the material to be coated.

### Intermediate Coating Layer-Forming Step

The intermediate coating layer-forming step can be executed by directly applying the intermediate coating paint onto the surface of the electrodeposition coating layer, and then as needed, baking.

As the intermediate coating paint, the intermediate coating composition described above may be used. The intermediate coating composition may be used either directly as the intermediate coating paint, or after diluting in a solvent to prepare an intermediate coating paint. Details of the intermediate coating composition are as described above; therefore, redundant explanations are omitted in this respect.

Application of the intermediate coating paint is usually carried out such that the intermediate coating layer after drying has a film thickness of no less than 5 μm and no greater than 60 μm. Such an application of the intermediate coating paint may be conducted using a well-known coater such as a spray type paint applicator, or the like. Examples of the spray type paint applicator include air spray paint applicators, airless spray paint applicators, air spray type electrostatic paint applicators, rotational electrostatic paint applicators, and the like.

Baking after the application of the intermediate coating paint may be carried out in accordance with a conventional method. The baking is preferably carried out under conditions involving, for example, the baking temperature of no less than 130° C. and no greater than 160° C., and the baking time period of no less than 10 min and no greater than 60 min. In addition, the baking in the intermediate coating layer-forming step may be omitted, and a top coating paint as described later may be applied onto the intermediate coating paint by a wet-on-wet system.

### Top Coating Layer-Forming Step

The top coating layer-forming step may be executed by applying the top coating paint on the intermediate coating layer (or intermediate coating paint), followed by baking.

In the top coating layer-forming step, when formation of a monolayer of only a base layer is intended, the top coating paint is applied, and thereafter baking is carried out.

In this instance, the top coating paint which may be used is any well-known top coating solid paint that contains, for example, a resin component such as an acrylic resin, a polyester resin or a fluorocarbon resin, a coloring pigment, and the like. The film thickness of the top coating layer of the monolayer after baking is typically no less than 2 μm and no greater than 60 μm.

In addition, when the top coating layer is formed to have two layers, the clear paint is applied by a wet-on-wet system after the application of the solid paint, and the baking of the solid paint and the clear paint is concurrently carried out.

It is to be noted that when the baking is not carried out in the intermediate coating layer-forming step, the intermediate coating paint is concurrently baked during the baking in the top coating layer-forming step. The baking is preferably carried out under conditions involving, for example, the baking temperature of no less than 130° C. and no greater than 160° C., and the baking time period of no less than 10 min and no greater than 60 min.

According to such a multilayered coating film-forming method, the intermediate coating layer is formed using the intermediate coating composition; therefore, even if a chipping-resistant primer is not applied, a multilayered coating film capable of ensuring the chipping resistance can be formed.

### Multilayered Coating Film

The multilayered coating film according to the embodiment of the present invention is formed on a material to be coated constructing a vehicle outer panel. The multilayered coating film includes an electrodeposition coating layer formed on the surface of the material to be coated, an intermediate coating layer directly overlaid on the surface of the electrodeposition coating layer, and a top coating layer overlaid on the surface of the intermediate coating layer. The multilayered coating film is applicable to outer panels of automobiles, as well as other outer panels of e.g., motor cycles, fork-lift trucks and heavy equipment, automobile accessories, and the like for which chipping resistance is required.

Material to be Coated

The material to be coated is not particularly limited, and may be selected depending on an intended usage of the plate to be painted, and the like. For example, when the plate to be painted is an outer panel of automobiles, the material to be coated is exemplified by steel plates, and steel plates which had been subjected to plating with zinc, etc., and/or to chemical conversion coating. The material to be coated for outer panels of automobiles is preferably one which had been subjected to plating, followed by chemical conversion coating.

Electrodeposition Coating Layer

The electrodeposition coating layer is provided predominantly for ensuring an anticorrosion property. The constitution and the like of the electrodeposition coating layer may be selected depending on the characteristics and the like required for the vehicle outer panels.

Examples of the resin component employed as the principal component of the electrodeposition coating layer include: drying oils, liquid rubber-based resins such as polybutadiene and maleinized polybutadiene, maleinized oil resins, amine epoxidized polybutadiene; fatty acid ester resins of a resinous polyol, or modified derivatives thereof (for example, epoxidation products and esterification products); alkyd resins; acrylic resins; and the like.

The electrodeposition coating layer may contain well-known additive(s) such as a melamine resin, a crosslinking agent such as a blocked isocyanate, a pigment, and the like.

The film thickness of the electrodeposition coating layer is typically no less than 10 μm and no greater than 40 μm. When the film thickness of the electrodeposition coating layer falls within such a range, the anticorrosion property can be suitably ensured.

Intermediate Coating Layer

The intermediate coating layer is provided predominantly for ensuring smoothness and chipping resistance. The intermediate coating layer is formed by using the intermediate coating composition described above. Thus, the intermediate coating layer has the characteristics (1) to (4) described above as characteristics of the coating film obtained by curing the intermediate coating composition alone, and the intermediate coating layer preferably has the characteristic (5) described above.

The film thickness of the intermediate coating layer is preferably no less than 5 μm and no greater than 60 μm. When the film thickness of the intermediate coating layer is less than 5 μm, the smoothness and chipping resistance may not be ensured. On the other hand, when the film thickness of the intermediate coating layer is greater than 60 μm, the paint in the intermediate coating layer and the paint in the top coating layer are admixed with each other in a case where, for example, the top coating layer is formed according to a wet-on-wet system, and thus the smoothness may not be ensured.

Top Coating Layer

The top coating layer is provided predominantly for ensuring the smoothness and corrosion resistance, and as needed, gives a multicolored pattern, whereby visual effects such as an optical effect are achieved.

The top coating layer may be formed either as a monolayer or a multilayer. The number of layers of the top coating layer may be selected depending on the intended usage and the like of the plate to be painted. For example, in the case of outer panels of automobiles, the number of layers of the top coating layer may be generally either one or two.

When the top coating layer is formed as a monolayer, the top coating layer contains, for example, a resin component, a coloring pigment, and/or the like. The resin component is exemplified by a resin blended into a well-known top coating solid paint such as e.g., an acrylic resin, polyester resin, a fluorocarbon resin, and the like. The coloring pigment is appropriately selected from well-known coloring pigments. The film thickness of the top coating layer is typically no less than 2 μm and no greater than 60 μm.

When the top coating layer is formed as a bilayer, the top coating layer includes, for example, a base layer and a clear layer. The base layer is fundamentally similar to the top coating layer of the monolayer. The clear layer is transparent layer, and protects the base layer. This clear layer contains, for example, a fluorocarbon resin, as a resin component.

According to such a multilayered coating film, since the intermediate coating layer is formed by using the intermediate coating composition, the chipping resistance can be ensured even if the chipping-resistant primer is not applied.

### EXAMPLES

Hereinafter, embodiments of the present invention will be explained in more detail by way of Examples, but the present invention is not in any way limited to the following Examples. It is to be noted that, in Examples below, the term “part” means “part by mass”.

### Preparation of Intermediate Coating Composition

Each component for use in the preparation of the intermediate coating compositions is shown below.

### (a) Component

polycaprolactonetriol: “PLACCEL L320AL” available from Daicel Chemical Industries, Ltd.

### (b) Component

blocked isocyanate A: “Desmodur BL3175”, available from Sumika Bayer Urethane Co., Ltd.

blocked isocyanate B: “DURANATE™ MFK60X”, available from Asahi Kasei Chemicals Corporation

blocked isocyanate C: “DURANATE™ MFB60X”, available from Asahi Kasei Chemicals Corporation

blocked isocyanate D: “Desmodur BL3475”, available from Sumika Bayer Urethane Co., Ltd.

### (c) Component

polyester resin A: a polyester resin synthesized in the following Production Example 1

polyester resin B: a polyester resin synthesized in the following Production Example 2

### (d) Component

acrylic resin A: hydroxyl group-containing acrylic resin “a” (acrylic resin having a low Tg of −17° C.) described in the specification of Japanese Patent No. 4477483 (Synthesis Example 1)

acrylic resin B: hydroxyl group-containing acrylic resin “b” (acrylic resin having a low Tg of −16° C.) described in the specification of Japanese Patent No. 4477483 (Synthesis Example 2)

acrylic resin C: hydroxyl group-containing acrylic resin “c” (acrylic resin having a low Tg of −23° C.) described in the specification of Japanese Patent No. 4477483 (Synthesis Example 3)

acrylic resin D: “PLACCEL DC2209”, available from Daicel Chemical Industries, Ltd. (lactone-modified acrylic resin)

### Pigment Components

talc: “LMR-100”, available from Fuji Talc Industrial Co., Ltd.

titanium white: “Tipaque CR97”, available from Ishihara Sangyo Kaisha, Ltd.

carbon black: “Carbon Black MA-100”, available from Mitsubishi Chemical Corporation

sedimentary barium sulfate: “BARTEX OWT”, available from TOR MINERALS international Inc.

### Production Example 1

### Synthesis of Polyester Resin A

Into a reaction chamber equipped with a thermometer, a stirrer, a condenser, a nitrogen inlet tube, a water separator and a rectifying column, 45.5 parts of isophthalic acid, 17.1 parts of adipic acid, 10.0 parts of trimethylolpropane, 35.9 parts of neopentyl glycol, 5.0 parts of versatic acid glycidyl ester (“Cardura E”, available from Shell Chemical Co., Ltd.), and 0.3 parts of dibutyltin oxide were charged, and the mixture was heated To elevate the temperature to 210° C. In this procedure, within the temperature range of from 160° C. to 210° C., the temperature was elevated over 3 hrs at a constant rate of temperature rise. Thus produced condensation water was distilled away outside the system. When the temperature of the reaction chamber reached 210° C., the temperature was maintained. After the incubation for 1 hour, 47.8 parts of isobutyl acetate were gradually added as a reflux solvent into the reaction chamber so as to proceed the reaction after switching to condensation in the presence of a solvent. Thereafter, the reaction chamber was cooled to 150° C., and 11.4 parts of ε-caprolactone were added. The mixture was incubated at 150° C. for 2 hrs, and then cooled to 100° C. Accordingly, a varnish was obtained in which a number average molecular weight was 3,050, an acid value was 8.0 mg KOH/g (solid content), a hydroxyl value was 92 mg KOH/g (solid content) and a nonvolatile matter content was 75% was obtained. It is to be noted that the number average molecular weight (Mn) was measured on gel permeation chromatography (GPC), and determined by a conversion using the polystyrene molecular weight as a standard.

### Production Example 2

### Synthesis of Polyester Resin B

Into a reaction chamber equipped with a thermometer, a stirrer, a condenser, a nitrogen inlet tube, a water separator and a rectifying column, 18.4 parts of isophthalic acid, 7.2 parts of hydroxypivalic acid neopentyl glycol ester, 21.3 parts of trimethylolpropane, 18.0 parts of neopentyl glycol, 25.8 parts of hexahydrophthalic anhydride, 9.4 parts of versatic acid glycidyl ester (“Cardura E”, available from Shell Chemical Co., Ltd.), and 0.02 parts of dibutyltin oxide were charged, and the mixture was heated to elevate the temperature to 210° C. In this procedure, within the temperature range of from 160° C. to 210° C., the temperature was elevated over 3 hrs at a constant rate of temperature rise. Thus produced condensation water was distilled away outside the system. When the temperature of the reaction chamber reached 210° C., the temperature was maintained. After the incubation for 1 hour, 26.4 parts of isobutyl acetate were gradually added as a reflux solvent into the reaction chamber so as to proceed the reaction after switching to condensation in the presence of a solvent. Thereafter, the reaction chamber was cooled to 150° C., and 11.4 parts of ε-caprolactone were added. The mixture was incubated at 150° C. for 2 hrs, and then cooled to 100° C. Accordingly, a varnish was obtained in which a number average molecular weight was 1,310, an acid value was 8.7 mg KOH/g (solid content), a hydroxyl value was 210 mg KOH/g (solid content) and a nonvolatile matter content was 78.5% was obtained. It is to be noted that the number average molecular weight (Mn) was measured on gel permeation chromatography (GPC), and determined by a conversion using the polystyrene molecular weight as a standard.

### Example 1

The polycaprolactonetriol in an amount of 46.25% by mass (percentage content in entire resin solid components); 19.67% by mass (percentage content in entire resin solid components) of the blocked isocyanate A; 34.08% by mass (percentage content in entire resin solid components) of the polyester resin A; 1.35% by mass (pigment mass concentration) of the talc; 6.16% by mass (pigment mass concentration) of the titanium white; 1.17% by mass (pigment mass concentration) of the carbon black; and 28.74% by mass (pigment mass concentration) of the sedimentary barium sulfate were mixed, and the mixture was stirred to prepare the intermediate coating composition of Example 1. In this procedure, the molar ratio (NCO/OH ratio) of NCO groups in the blocked isocyanate A to OH groups in the polycaprolactonetriol is 1.

### Examples 2 to 11 and Comparative Examples 1 to 3

Intermediate coating compositions of Examples 2 to 11 and Comparative Examples 1 to 3 were prepared in a similar manner to Example 1 except that each formulation was as shown in Table 1 below. The value of the NCO/OH ratio in the preparation of each intermediate coating composition is also shown in Table 1 together. It is to be noted that “-” denotes that the corresponding component was not blended.

### Formation of Multilayered Coating Film

Multilayered coating films were formed using the intermediate coating compositions of Examples 1 to 11 and Comparative Examples 1 to 3 in accordance with the following method.

A GA steel plate (alloyed melt zinc-plated steel plate) was subjected to electrodeposition paint application with a cation electrodeposition coating composition (“POWER NICS® 1010”, available from Nippon Paint Co., Ltd.) such that the dry coating film had a thickness of 15 μm, and heated at 170° C. for 20 min and thereafter cooled to form a cured electrodeposition coating layer.

Subsequently, on the cured electrodeposition coating layer, paint application was executed so as to give the film thickness of 35 μm by an air spray paint application with the intermediate coating composition at room temperature, and then curing was allowed at 140° C. for 30 min. On the intermediate coating film, paint application was executed so as to give the film thickness of 15 μm by an air spray paint application with a base coating composition (“Aquarex AR-2000”, available from Nippon Paint Co., Ltd.) as the top coating composition, and then preheating was carried out at 80° C. for 3 min. Furthermore, on the coating film of the base coating composition, paint application was executed so as to give the film thickness of 35 μm by an air spray paint application with a clear coating composition (“MACFLOW O-1830”, available from Nippon Paint Co., Ltd.) as the top coating composition, and then heat curing was carried out at 140° C. for 30 min to obtain a test piece having a multilayered coating film.

It is to be noted that the intermediate coating composition, the base coating composition and the clear coating composition were employed for the paint application after diluting to give a certain viscosity using the dilution solvent described below.

### Intermediate Coating Composition

Using a mixed solvent of isobutyl acetate and n-pentyl propionate with a volume ratio of 1:1 as the dilution solvent, the dilution was carried out such that the viscosity (20° C.) as indicated by the measurement with a Ford Cup Viscometer (cup No. 4) was 35 sec.

### Top Coating Composition

Base Coating Composition

Using ion exchanged water as the dilution solvent, the dilution was carried out such that the viscosity (20° C.) as indicated by the measurement with a Ford Cup Viscometer (cup No. 4) was 45 sec.

Clear Coating Composition

Using a mixed solvent of EEP (ethoxyethyl propionate) and S150 (trade name; aromatic hydrocarbon solvent, manufactured by Exxon Corporation) with a volume ratio of 1:1 as the dilution solvent, the dilution was carried out such that the viscosity (20° C.) as indicated by the measurement with a Ford Cup Viscometer (cup No. 4) was 28 sec.

### Evaluations

Intermediate coating compositions of Examples 1 to 11 and Comparative Examples 1 to 3, and test pieces having an intermediate coating layer formed using these intermediate coating compositions were evaluated in accordance with the following methods. The results of these evaluations are shown in Table 1.

### Chipping Resistance (Flaking of Coating Film, Flaking of Zinc Plating Layer)

Using a Gurabero tester (Suga Test Instruments Co., Ltd.), 300 g of No. 6 crushed stones were allowed to collide onto the multilayered coating film of the test piece at an angle of 90° from a point a distance of 35 cm away, with an air pressure of 5 kgf/cm². After washing with water and drying, flaking coating film pieces were removed by using a gummed kraft paper tape for industrial use (Nichiban Co., Ltd.), and then the extent of the flaking of the coating film was visually observed. The chipping resistance was evaluated based on the following evaluation criteria in view of the state of the flaking of the coating film. With respect to the flaking of the coating film, evaluations A and B were decided to be acceptable in the following five-grade rating. In addition, the flaking of the zinc plating layer was checked based on as to whether or not the dull steel plate was exposed. The evaluation was made as “B” when the dull steel plate was exposed, whereas the evaluation was made as “A” when the dull steel plate was not exposed.

Flaking of Coating Film

A: excellent (not any flaking of the coating film being found);

B: favorable (flaking of the coating film being slightly found);

C: normal (flaking of no greater than 1 mmφ of the coating film being frequently found);

D: somewhat unfavorable (flaking of the coating film being remarkable); and

E: unfavorable (the area of flaking of the coating film being great)

### Loss Tangent (tan δ) and Dynamic Tg at −20° C.

On a polypropylene test plate, paint application was executed so as to give the dry thickness of the single film of no less than 20 μm and no greater than 50 μm by an air spray paint application with the intermediate coating composition, and a coating film was formed by heat curing carried out at 140° C. for 30 min. Next, a test piece was prepared through flaking of the coating film from the test plate, and cutting to give a size of 5 mm×20 mm. The test piece was subjected to a measurement of a dynamic viscoelasticity using an enforced stretching vibration type viscoelasticity meter (“Vibron” available from ORIENTEC Co., LTD) under conditions involving a rate of temperature rise of 2° C./min and a measurement frequency of 8 Hz, and the loss tangent (tan δ) at −20° C. was determined from a phase shift generated between the stress and the vibration strain occurring in temperature rise. In addition, the dynamic Tg of the coating film was determined as a temperature measured when the loss tangent (tan δ) exhibited a maximum value.

### Percentage of Elongation, Young's Modulus and Tensile Strength

On a polypropylene test plate, paint application was executed so as to give the dry thickness of the single film of no less than 20 μm and no greater than 50 μm by an air spray paint application with the intermediate coating composition, and a coating film was formed by heat curing carried out at 140° C. for 30 min. Next, a test piece was prepared through flaking of the coating film from the test plate, and cutting to give a size of 10 mm×70 mm. The test piece was subjected to a measurement using a tensile testing machine and an analog meter (“Autograph model AGS-G”, available from Shimadzu Corporation), with a measurement length of 50 mm, at a temperature of −20° C. and a strain rate of 10 mm/min. The percentage of elongation was determined in accordance with a formula of:

percentage of elongation(%)=(L−X)×100/X,

wherein X (mm) is the length along the axis direction of the test piece before the test, and L (mm) is the length along the axis direction of the test piece when broken. The Young's modulus was determined based on the slope of the graph obtained by the tensile test at an initial point. The tensile strength means the maximum tensile stress until the test piece is broken, and was determined in accordance with the formula of:

tensile strength=Pmax/A(kgf/cm²),

wherein Pmax (kgf) is the maximum load upon breaking, and A (cm²) is the cross sectional area of the coating film.

TABLE 1

| | | | Example | Example | Example | Example | Example | Example | Example | Example, | Example | Example | Example | Comparative | Comparative | Comparative |
|---|---|---|---|---|---|---|---|---|---|---|---|---|---|---|---|---|
| | | | 1 | 2 | 3 | 4 | 5 | 6 | 7 | 8 | 9 | 10 | 11 | Example 1 | Example 2 | Example 3 |
| Resin | (a) component | polycaprolactonetriol | 46.25 | 40.27 | 35.63 | 31.97 | 18.70 | 25.41 | 27.10 | 15.70 | 25.65 | 43.35 | 26.56 | — | — | — |
| components | (b) component | blocked isocyanate A | 19.67 | 25.65 | 30.29 | 33.95 | — | — | 12.57 | — | — | — | — | — | — | — |
| (*1) | | blocked isocyanate B | — | — | — | — | 29.37 | — | — | 11.98 | 15.83 | 23.40 | — | 31.97 | 29.81 | 29.81 |
| | | blocked isocyanate C | — | — | — | — | — | — | — | — | — | — | 13.64 | — | — | — |
| | | blocked isocyanate D | — | — | — | — | — | 15.90 | — | — | — | — | — | — | — | — |
| | (c) component | poly ester resin A | 34.08 | 34.08 | 34.08 | 34.08 | 33.25 | 33.25 | 33.25 | 33.25 | 33.25 | 33.25 | 33.25 | 33.25 | 33.25 | 33.25 |
| | | poly ester resin B | — | — | — | — | 18.70 | — | — | — | — | — | — | — | — | — |
| | (d) component | acrylic resin A | — | — | — | — | — | — | — | — | — | — | — | 34.79 | — | — |
| | | (low Tg) | | | | | | | | | | | | | | |
| | | acrylic resin B | — | — | — | — | — | — | — | — | — | — | — | — | 36.95 | — |
| | | (low Tg) | | | | | | | | | | | | | | |
| | | acrylic resin C | — | — | — | — | — | — | — | — | — | — | — | — | — | 36.95 |
| | | (low Tg) | | | | | | | | | | | | | | |
| | | acrylic resin D | — | — | — | — | — | 25.41 | 27.10 | 43.31 | 25.65 | — | 26.56 | — | — | — |
| | | (lactone-modified) | | | | | | | | | | | | | | |
| Pigment | | talc | 1.35 | — | — | — | 3.00 | 3.00 | 3.00 | — | — | — | 3.00 | 1.35 | — | — |
| component | | titanium white | 6.16 | — | — | — | 34.75 | 34.75 | 34.75 | — | — | — | 34.75 | 6.16 | — | — |
| (*2) | | carbon black | 1.17 | — | — | — | 0.02 | 0.02 | 0.02 | — | — | — | 0.02 | 1.17 | — | — |
| | | sedimentary barium | 28.74 | — | — | — | 13.90 | 13.90 | 13.90 | — | — | — | 13.90 | 28.74 | — | — |
| | | sulfate | | | | | | | | | | | | | | |
| | | total pigment mass | 37.43 | — | — | — | 52.00 | 52.00 | 52.00 | — | — | — | 52.00 | 37.43 | — | — |
| | | concentration | | | | | | | | | | | | | | |
| NCO/OH ratio | | | 1 | 1.5 | 2 | 2.5 | 0.37 | 0.57 | 0.8 | 1.1 | 1.1 | 1.1 | 1 | 1.1 | 1.1 | 1.1 |
| Evaluations | characteristics | tan δ (−20° C.) | 0.36 | 0.19 | 0.08 | 0.06 | 0.03 | 0.21 | 0.06 | 0.13 | 0.21 | 0.50 | 0.20 | 0.02 | 0.02 | 0.02 |
| | of the | dynamic glass | −10 | 0 | 10 | 16 | 26 | 4 | 18 | 10 | 4 | −14 | 2 | 56 | 56 | 58 |
| | intermediate | transition | | | | | | | | | | | | | | |
| | coating film | temperature (° C.) | | | | | | | | | | | | | | |
| | | percentage of | 205 | 159 | 128 | 71 | 7.7 | 79 | 25 | 11.2 | 96.2 | 159 | 46.3 | 2.2 | 2.7 | 2.9 |
| | | elongation at | | | | | | | | | | | | | | |
| | | −20° C. (%) | | | | | | | | | | | | | | |
| | | Young's modulus at | 878 | 5548 | 10440 | 11210 | 19850 | 4148 | 13300 | 6450 | 5310 | 649 | 4810 | 27720 | 24170 | 20400 |
| | | −20° C. (kgf/cm2) | | | | | | | | | | | | | | |
| | | tensile strength at | 835 | 582 | 947 | 1020 | 513 | 312 | 425 | 227 | 292 | 460 | 239 | 606 | 552 | 560 |
| | | −20° C. (kgf/cm2) | | | | | | | | | | | | | | |
| | chipping | flaking of coating | B | A | B | B | B | B | B | C | C | B | C | E | E | E |
| | resistance | film | | | | | | | | | | | | | | |
| | | flaking of zinc | A | A | A | A | A | A | A | A | A | A | A | B | B | B |
| | | plating layer | | | | | | | | | | | | | | |

*1: percentage content in entire resin solid components (mass %)
*2: pigment mass concentration (mass %)

From the results shown in Table 1, it was indicated that the intermediate coating compositions Examples 1 to 11 enable coating films that are superior in chipping resistance to be formed even when a chipping-resistant primer is not applied.

### INDUSTRIAL APPLICABILITY

According to the intermediate coating composition, the multilayered coating film and the multilayered coating film-forming method of the embodiments of the present invention, multilayered coating film that is superior in chipping resistance can be formed even when a chipping-resistant primer is not applied.

What is claimed is:

1. An intermediate coating composition used in forming an intermediate coating layer directly overlaid on a surface of an electrodeposition coating layer constructing a vehicle outer panel, wherein
a coating film obtained by curing of the intermediate coating composition alone has following characteristics (1) to (4):
(1) a loss tangent (tan δ) at −20° C. as determined from a measurement of a dynamic viscoelasticity under a condition involving a rate of temperature rise of 2° C./min and a frequency of 8 Hz being no less than 0.01 and no greater than 0.5;
(2) a dynamic glass transition temperature (dynamic Tg) being no less than −15° C. and no greater than 55° C.;
(3) percentage of elongation at −20° C. being no less than 1% and no greater than 250%; and
(4) a Young's modulus at −20° C. being no less than 400 kgf/cm² and no greater than 50,000 kgf/cm².

2. The intermediate coating composition according to claim 1, wherein the coating film has following characteristic (5):
(5) a tensile strength at −20° C. being no less than 200 kgf/cm² and no greater than 1,200 kgf/cm².

3. The intermediate coating composition according to claim 1 comprising a polycaprolactonetriol and a blocked isocyanate as resin components.

4. The intermediate coating composition according to claim 1 comprising a laminar filler as a pigment component.

5. A multilayered coating film comprising:
an electrodeposition coating layer constructing a vehicle outer panel; an intermediate coating layer directly overlaid on a surface of the electrodeposition coating layer; and
a top coating layer overlaid on a surface of the intermediate coating layer,
wherein the intermediate coating layer is formed from the intermediate coating composition according to claim 1.

6. A multilayered coating film-forming method comprising:
forming an electrodeposition coating layer constructing a vehicle outer panel;
directly forming an intermediate coating layer overlaid on a surface of the electrodeposition coating layer; and
forming a top coating layer overlaid on a surface of the intermediate coating layer,
wherein the intermediate coating composition according to claim 1 is applied in forming the intermediate coating layer.
